(19) United States
(12) Patent Application Publication
(10) Pub. No.: US 2013/0214118 A1
(43) Pub. Date: Aug. 22, 2013

(54) TORSION-BASED LUMINAIRE SUSPENSION MECHANISM

(71) Applicants: Anil Jeswani, Beverly, MA (US); Fernando Aguiar, Westport, MA (US); Ronald Roberts, Melrose, MA (US); Sara Lincoln, Somerville, MA (US)

(72) Inventors: Anil Jeswani, Beverly, MA (US); Fernando Aguiar, Westport, MA (US); Ronald Roberts, Melrose, MA (US); Sara Lincoln, Somerville, MA (US)

(73) Assignee: OSRAM SYLVANIA INC., Danvers, MA (US)

(21) Appl. No.: 13/400,463

(22) Filed: Feb. 20, 2012

(51) Int. Cl. F21V 21/104

(52) U.S. Cl. 248/613; 248/343

(57) ABSTRACT

A luminaire suspension mechanism is provided. The mechanism includes two arms, two friction elements, and a compression element. Each arm includes three segments and two connection points. For each arm, a first segment attaches to a second segment at a connection point, forming a first angle, while the second segment attaches to a third segment at another connection point, forming a second angle. Each friction element is connected to a respective arm's third segment. Each arm's first segment is compressably attached to the compression element, such that a force applied to at least one of the arm-friction element pairs results in the compression element and that at least one pair exerting a suspending force that suspends a luminaire to which the luminaire suspension mechanism is attached within a cavity. The compression element may be a torsion spring, and the angles formed by the arm segments may be obtuse.

### TECHNICAL FIELD

The present invention relates to lighting, and more specifically, to suspension mechanisms for luminaires.

### BACKGROUND

A solid state light source-based recessed luminaire is usually installed in a recessed fixture having a recessed opening in, for example, a ceiling. The solid state light-source based luminaire may replace a lamp, for example a PAR-type lamp (i.e., PAR 30, PAR 38, PAR 40, etc.) having any type of light source (i.e., incandescent, halogen, fluorescent, compact fluorescent, solid state light source, etc.), or the recessed fixture itself and the lamp contained therein. When replacing a lamp, a typical solid state light source-based luminaire uses either a conventional torsion spring or spring clips so as to suspend the luminaire within the recessed opening of the recessed fixture. An installer pinches the arms of the spring together, or pinches the clips in towards the fixture, and then pushes the luminaire up into the recessed opening.

### SUMMARY

A conventional torsion spring suffers from a variety of disadvantages. Only certain types of recessed fixtures are compatible with a conventional torsion spring. The recessed fixture must be able to accept the spring, or the luminaire cannot be installed therein. Further, a conventional torsion spring places all, or substantially all, of the pressure of suspending the luminaire within the recessed opening of the fixture. A conventional torsion spring thus relies entirely, or almost entirely, on the fixture to support the weight of the luminaire, so that the luminaire remains flush with the surface and does not fall out of the opening. As solid state light sources typically last far longer than conventional light sources, and as solid state light source-based luminaires are typically heavy due to the need for metal thermal management systems, this may be asking the recessed fixture to do too much of the work. In other words, a luminaire having a conventional torsion spring may result in the recessed fixture failing to hold the luminaire in place over time. A user may then have to constantly push the luminaire up, so that it looks proper. Worse, the luminaire may fall out, damaging the fixture, if not person(s) and/or property located underneath the fixture.

Embodiments of the present invention provide a modified torsion spring that serves as a luminaire suspension mechanism. The arms of the luminaire suspension mechanism are not straight, as in a conventional torsion spring, but rather are bent so as to provide a more secure and longer-lasting installation of a luminaire in, for example, the opening of a recessed fixture. This is achieved through a different pattern of forces acting on the interior of the opening of the recessed fixture, due to the bends in the arms. The luminaire suspension mechanism described herein results in an easier installation experience as well, but creating a pull up force that helps to suck the luminaire into the opening during installation.

In an embodiment, there is provided a luminaire suspension mechanism. The luminaire suspension mechanism includes: a first arm and a second arm, each of the first arm and the second arm including: a first segment; a second segment; a third segment; a first connection point; and a second connection point; wherein the first segment and the second segment attach at the first connection point, forming a first angle therebetween, wherein the second segment and the third segment attach at the second connection point, forming a second angle therebetween; a first friction element and a second friction element, wherein the first friction element is connected to the third segment of the first arm and the second friction element is connected to the third segment of the second arm; and a compression element, wherein the first segment of each of the first arm and the second arm are compressably attached to the compression element, such that a force applied to at least one of the connected first arm and the first friction element and the connected second arm and the second friction element results in the compression element and at least one of the connected first arm and the first friction element and the connected second arm and the second friction element exerting a suspending force so as to suspend a luminaire to which the luminaire suspension mechanism is attached within a cavity.

In a related embodiment, the first arm may have a lower surface and an upper surface, and the second arm may have an upper surface and a lower surface.

In a further related embodiment, a first arc created between the upper surface of the first arm and the upper surface of the second arm about the compression element may have an angle of less than 180°. In a further related embodiment, a second arc created between the lower surface of the first arm and the lower surface of the second arm about the compression element may have an angle of greater than 180°. In a further related embodiment, the second arc may not intersect the upper surface of the first arm or the upper surface of the second arm.

In another related embodiment, a first connection angle may be formed on the lower surface of the first arm between the first segment and the second segment of the first arm. In a further related embodiment, a second connection angle may be formed on the upper surface of the first arm between the second segment and the third segment of the first arm.

In a further related embodiment, at least one of the first connection angle and the second connection angle may be obtuse. In another further related embodiment, the first connection angle may be obtuse, and the second connection angle may be obtuse.

In yet another further related embodiment, a third connection angle may be formed on the lower surface of the second arm between the first segment and the second segment of the second arm. In a further related embodiment, a fourth connection angle may be formed on the upper surface of the second arm between the second segment and the third segment of the second arm. In a further related embodiment, at least one of the third connection angle and the fourth connection angle may be obtuse. In another further related embodiment, the third connection angle may be obtuse, and the fourth connection angle may be obtuse.

In yet another related embodiment, the compression element may be a torsion spring. In a further related embodiment, the torsion spring may have at least two windings.

In still another related embodiment, the first friction element and the second friction element may each have a curved end and a pinched end. In yet still another related embodiment, the first arm, the second arm, the first friction element, the second friction element, and the compression element may be formed from the same piece of material. In still yet another related embodiment, the suspending force exerted by the compression element and at least one of the connected first arm and the first friction element and the connected second arm and the second friction element may include a pulling force that results in the luminaire being at least partially pulled into the cavity.

### BRIEF DESCRIPTION OF THE DRAWINGS

The foregoing and other objects, features and advantages disclosed herein will be apparent from the following description of particular embodiments disclosed herein, as illustrated in the accompanying drawings in which like reference characters refer to the same parts throughout the different views. The drawings are not necessarily to scale, emphasis instead being placed upon illustrating the principles disclosed herein.

FIG. 1 shows a luminaire suspension mechanism according to embodiments disclosed herein.

FIG. 2 is an isometric view of the luminaire suspension mechanism of FIG. 1 according to embodiments disclosed herein.

### DETAILED DESCRIPTION

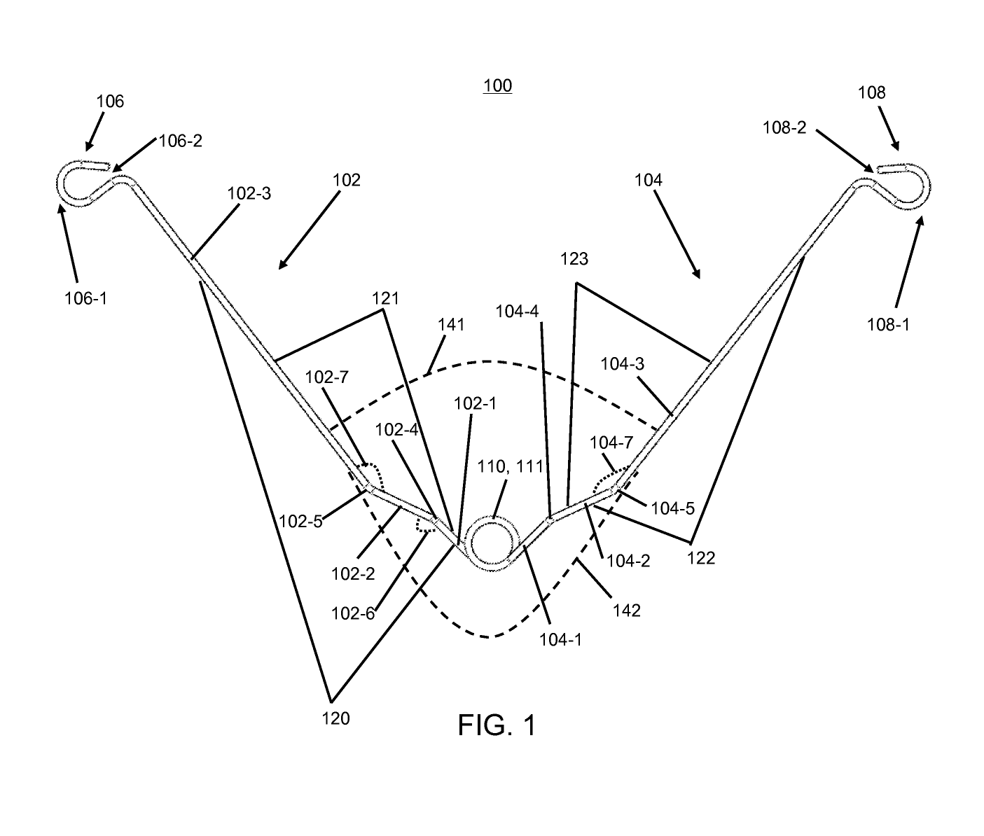

FIG. 1 shows a luminaire suspension mechanism 100, according to embodiments disclosed herein. The luminaire suspension mechanism 100 is typically attached to a solid state light source-based luminaire, though of course it may also be used with other luminaires without departing from the scope of the invention. As used throughout, the term “solid state light source” includes one or more light emitting diodes (LEDs), organic light emitting diodes (OLEDs), polymer light emitting diodes (PLEDs), and the like, including combinations thereof. The luminaire suspension mechanism 100 helps to achieve a positive pull during installation of the luminaire to which it is attached, making the installation easier and taking less time. The luminaire suspension mechanism 100 also helps to retain the luminaire to which it is attached inside a cavity, such as but not limited to an opening in a recessed fixture, so that the luminaire does not slip below a surface (e.g., a ceiling) over time, or fallout of the cavity over time.

The luminaire suspension mechanism 100 includes a first arm 102 and a second arm 104, and a first friction element 106 and a second friction element 108. The first arm 102 includes a first segment 102-1, a second segment 102-2, and a third segment 102-3. A first connection point 102-4 of the first arm 102 is located between the first segment 102-1 and the second segment 102-2. A second connection point 102-5 of the first arm 102 is located between the second segment 102-2 and the third segment 102-3. Thus, the first segment 102-1 and the second segment 102-2 of the first arm 102 attach at the first connection point 102-4, and form a first angle 102-6 therebetween. The second segment 102-2 and the third segment 102-3 of the first arm 102 attach at the second connection point 102-5, and form a second angle 102-7 therebetween. The third segment 102-3 is attached to the first friction element 106. That is, the first friction element 106 connects to the first arm 102 via the third segment 102-3 of the first arm 102.

Similarly, the second arm 104 includes include a first segment 104-1, a second segment 104-2, and a third segment 104-3. A first connection point 104-4 of the second arm 104 is located between the first segment 104-1 and the second segment 104-2. A second connection point 104-5 of the second arm 104 is located between the second segment 104-2 and the third segment 104-3. Thus, the first segment 104-1 and the second segment 104-2 of the second arm 104 attach at the first connection point 104-4, and form a first angle 104-6 therebetween. The second segment 104-2 and the third segment 104-3 of the second arm 104 attach at the second connection point 104-5, and form a second angle 104-7 therebetween. The third segment 104-3 is attached to the second friction element 108. That is, the second friction element 108 connects to the second arm 104 via the third segment 104-3 of the second arm 104.

In some embodiments, the first arm 102 has a lower surface 120 and an upper surface 121, and similarly, the second arm 104 has a lower surface 122 and an upper surface 123. In embodiments where the first arm 102 has a circular cross-section, the lower surface 120 is the portion of each circular cross-section below the diameter of the circle, and the upper surface 121 is the portion of each circular cross-section above the diameter of the circle. Similarly, in embodiments where the second arm 104 has a circular cross-section, the lower surface 122 is the portion of each circular cross-section below the diameter of the circle, and the upper surface 123 is the portion of each circular cross-section above the diameter of the circle.

The first friction element 106 and the second friction element 108 contact one or more locations within a cavity (e.g., a recessed opening of a recessed fixture) from which a luminaire to which the luminaire suspension mechanism 100 is attached is to be suspended. The first friction element 106 and the second friction element 108, through this contact, help to suspend and/or retain the luminaire within the cavity, as is explained further below. For example, the first friction element 106 may rest against a clip or other piece that juts out from an interior surface of the opening of the recessed fixture. Similar, the second friction element 108 may simultaneously rest against a similar clip or similar other piece that juts out from the interior surface of the opening of the recessed fixture on a different part of the interior surface. Alternatively, or additionally, the first friction element 106 and/or the second friction element 108 may rest within a slot or other opening within the opening of the recessed fixture. The friction between the first friction element 106 and its corresponding receiving part of the recessed fixture, and/or the friction between the second friction element 108 and its corresponding receiving part of the recessed fixture, help to suspend the luminaire to which the luminaire suspension mechanism 100 is attached in the appropriate location in relation to the recessed fixture and the opening therein.

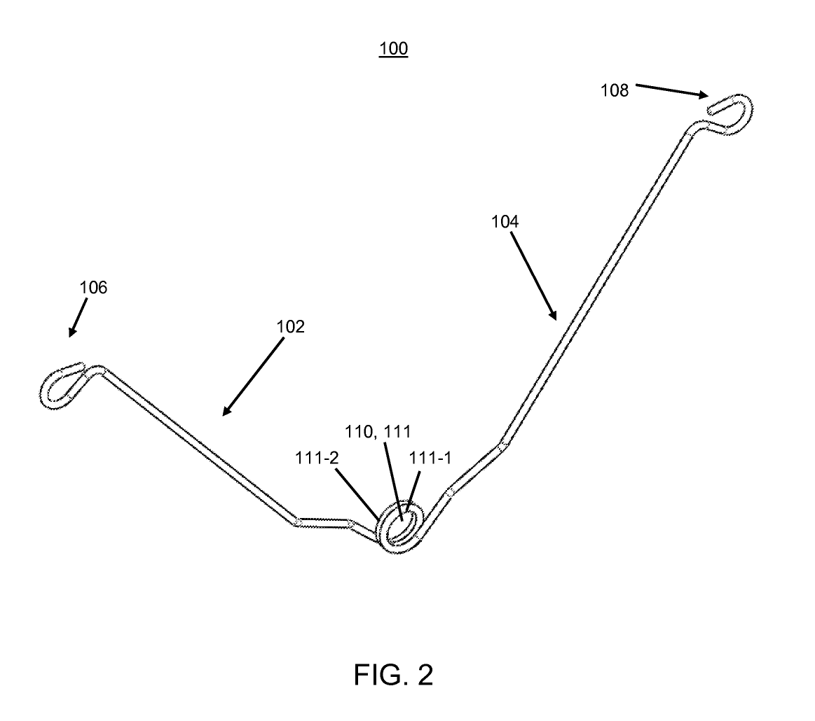

In some embodiments, such as is shown in FIGS. 1 and 2, the first friction element 106 includes a curved end 106-1 and a pinched end 106-2. Similarly, the second friction element 108 includes a curved end 108-1 and a pinched end 108-2. The curved end 106-1, 108-1, in some embodiments, serves as the portion of the first friction element 106/second friction element 108 that makes contact with the interior surface of the opening (i.e., cavity), or a portion thereof or connected thereto. The pinched end 106-2, 108-2 allows the first friction element 106/the second friction element 108 to be formed, in some embodiments, from the same piece of material (e.g., metal, plastic, etc.) as the rest of the luminaire suspension mechanism 100, as well as allowing the curved end 106-1, 108-1 to be curved. The connection between the first friction element 106 and the third segment 102-3 of the first arm 102 may be straight and/or substantially straight, that is, such that there is a 180° angle and/or a substantially 180° angle around the point at which the connection occurs. Alternatively, or additionally, as shown in FIGS. 1 and 2, the first friction element 106 may be bent in relation to the third segment 102-3 of the first arm 102. That is, the angle around the point at which the connection between the first friction element 106 and the third segment 102-3 of the first arm 102 occurs may be less than 180° or more than 180°. Similarly, the connection between the second friction element 108 and the third segment 104-3 of the second arm 104 may be straight and/or substantially straight, that is, such that there is a 180° angle and/or a substantially 180° angle around the point at which the connection occurs. Alternatively, or additionally, as shown in FIGS. 1 and 2, the second friction element 108 may be bent in relation to the third segment 104-3 of the second arm 104. That is, the angle around the point at which the connection between the second friction element 108 and the third segment 104-3 of the second arm 104 occurs may be less than 180° or more than 180°.

The luminaire suspension mechanism 100 also includes a compression element 110. The compression element 110 allows the first arm 102 and the second arm 104 to be compressed towards each other as needed. That is, the compression element 110 allows the first arm 102 to be moved towards the second arm 104 when a force is applied to first arm 102, moving it in a direction of the second arm 104. When the force is removed, however, the first arm 102 will move away from the second arm 104 and attempt to return to its original position (for example, as is seen in FIG. 1). If there is nothing preventing that (i.e., nothing that applies a force to hold the first arm 102 out of its original position), the first arm 102 will return to its original position. The second arm 104 behaves in the same way when a force is applied to it in a direction of the first arm 102, and similarly when such a force is removed.

The compression element 110 is attached to the first arm 102 via the first segment 102-1 of the first arm 102, and is attached to the second arm 104 via the first segment 104-1 of the second arm 104. The first segments 102-1, 104-1, and thus the first arm 102 and the second arm 104, are compressably attached to the compression element 110, such that a force applied to the first arm 102 and the second arm 104 (and the first friction element 106 and the second friction element 108, respectively attached thereto) will cause the first arm 102 and the second arm 104 (and the first friction element 106 and the second friction element 108, respectively attached thereto) to compress towards each other, and a removal of the force will cause the first arm 102 and the second arm 104 (and the first friction element 106 and the second friction element 108, respectively attached thereto) to decompress away from each other. In other words, a force that is applied to at least one of the connected first arm 102 and the first friction element 106, and the connected second arm 104 and the second friction element 108, results in the compression of at least one, and in some embodiments, both, of the first arm 102 (and the first friction element 106) and the second arm 104 (and the second friction element 108). Such compression occurs, for example, when a user is installing a luminaire to which the luminaire suspension mechanism 100 is attached. The user presses on the first arm 102 and the second arm 104, compressing them towards each other, to fit the luminaire suspension mechanism 100 within the space defined by the opening (i.e., cavity) of a recessed fixture. When the first friction element 106 and the second friction element 108, and at least a portion of the first arm 102 and the second arm 104, are within the cavity (i.e., opening), the user releases the first arm 102 and the second arm 104. The compression element 110 causes the first arm 102 and the second arm 104 to decompress (i.e., move away from each other) and attempt to return to their original position. However, in such situations, the first arm 102 (particularly, at least its connected first friction element 106) and the second arm 104 (particularly, at least its connected second friction element 108) come into contact with the interior surface of the opening, or in some embodiments, something connected thereto/located thereon. While the force applied by the user has been removed, the interior surface of the opening/something connected thereto/located thereon is now applying a force to at least one of the connected first arm 102 and the first friction element 106, and the connected second arm 104 and the second friction element 108. This results in a suspending force being exerted, so as to suspend a luminaire to which the luminaire suspension mechanism 100 is attached within the cavity (i.e., the opening of the recessed fixture). Depending on the design of the interior surface of the opening of the recessed fixture, and how it receives the first friction element 106 and the second friction element 108 (and possibly the first arm 102 and the second arm 104), a pulling up force may also be part of the suspending force, such that the luminaire to which the luminaire suspension mechanism 100 is attached is at least partially pulled into the cavity.

The first segment 102-1, the second segment 102-2, and the third segment 102-3 of the first arm 102 are connected in such a way that the first arm 102 is able to contribute to the suspending force, and in some embodiments, the pulling force, described above. The first segment 102-1 and the second segment 102-2 are connected such that a first connection angle 102-6, shown via a dotted line in FIG. 1, is formed on the lower surface 120 of the first arm 102 between the first segment 102-1 and the second segment 102-2 of the first arm 102. Similarly, the second segment 102-2 and the third segment 102-3 of the first arm 102 are connected such that a second connection angle 102-7, shown via a dotted line in FIG. 1, is formed on the upper surface 121 of the first arm 102 between the second segment 102-2 and the third segment 102-3 of the first arm 102. At least one of the first connection angle 102-6 and the second connection angle 102-7 is obtuse. In some embodiments, both the first connection angle 102-6 and the second connection angle 102-7 are obtuse. Similarly, the first segment 104-1, the second segment 104-2, and the third segment 104-3 of the second arm 104 are connected in such a way that the second arm 104 is able to contribute to the suspending force, and in some embodiments, the pulling force, described above. The first segment 104-1 and the second segment 104-2 are connected such that a third connection angle 104-6, shown via a dotted line in FIG. 1, is formed on the lower surface 122 of the second arm 104 between the first segment 104-1 and the second segment 104-2 of the second arm 104. Similarly, the second segment 104-2 and the third segment 104-3 of the second arm 104 are connected such that a fourth connection angle 104-7, shown via a dotted line in FIG. 1, is formed on the upper surface 123 of the second arm 104 between the second segment 104-2 and the third segment 104-3 of the second arm 104. At least one of the third connection angle 104-6 and the fourth connection angle 104-7 is obtuse. In some embodiments, both the third connection angle 104-6 and the fourth connection angle 104-7 are obtuse. In some embodiments, all of the first connection angle 102-6, the second connection angle 102-7, the third connection angle 104-6, and the fourth connection angle 104-7, are obtuse. Alternatively or additionally, some subset of the first connection angle 102-6, the second connection angle 102-7, the third connection angle 104-6, and the fourth connection angle 104-7, are obtuse.

In some embodiments, the compression mechanism 110 is a torsion spring 111, such as is shown in FIGS. 1 and 2. As is seen most clearly in FIG. 2, the torsion spring 111 includes at least two windings 111-1, 111-2, though of course more windings and/or less windings may be used without departing from the scope of the invention. So long as the compression element 110 allows compression of the first arm 102 (and its connected first friction element 106) and the second arm 104 (and its connected second friction element 108), the number of windings when the compression element 110 is a spring is not relevant. In embodiments where the compression element 110 is a spring, such as the torsion spring 111, this allows the luminaire suspension mechanism 100 to be formed entirely from the same piece of material. The material may be, but is not limited to, a metal, an alloy, a plastic, or any other material suitable for forming the luminaire suspension mechanism 100. Thus, the first arm 102, the second arm 104, the first friction element 106, the second friction element 108, and the compression element 110, in such embodiments, are all formed from the same piece of material.

In some embodiments, the first arm 102 and the second arm 104 are arranged about the compression element 110 as follows. A first arc 141, shown as a dashed curve in FIG. 1, may be formed between the upper surface 121 of the first arm 102 and the upper surface 123 of the second arm 104 about the compression element 110. In some embodiments, the first arc 141 subtends an angle that is less than 180°. In other words, a line segment from a first end of the first arc 141 to a point at the center of the compression element 110, and a line segment from a second end of the first arc 141 to the point at the center of the compression element 110, form an angle with respect to the first arc 141 that is less than 180°. More simply stated, the first arm 102 and the second arm 104 are angled with respect to the compression element 110 and thus are not straight when no compressing force is applied to either the first arm 102, the second arm 104, or both. A second arc 142, also shown as a dashed curve in FIG. 1, may be formed between the lower surface 120 of the first arm 102 and the lower surface 122 of the second arm 104 about the compression element 110. In some embodiments, the second arc 142 subtends an angle that is greater than 180°. That is, a line segment from a first end of the second arc 142 to the point at the center of the compression element 110, and a line segment from a second end of the second arc 142 to the point at the center of the compression element 110, form an angle with respect to the second arc 142 that is greater than 180°. The second arc 142 does not intersect the upper surface 121 of the first arm 102 or the upper surface 123 of the second arm 104. Further, in some embodiments, the angle subtended by the first arc 141 and the angle subtended by the second arc 142 add up to 360°, or to substantially 360°, when the compression element 110 has circular and/or substantially circular cross section, such as is shown in FIG. 1.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems.

Throughout the entirety of the present disclosure, use of the articles “a” and/or “an” and/or “the” to modify a noun may be understood to be used for convenience and to include one, or more than one, of the modified noun, unless otherwise specifically stated. The terms “comprising”, “including” and “having” are intended to be inclusive and mean that there may be additional elements other than the listed elements.

Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

Although the methods and systems have been described relative to a specific embodiment thereof, they are not so limited. Obviously many modifications and variations may become apparent in light of the above teachings. Many additional changes in the details, materials, and arrangement of parts, herein described and illustrated, may be made by those skilled in the art.

What is claimed is:

1. A luminaire suspension mechanism, comprising:
a first arm and a second arm, each of the first arm and the second arm comprising:
a first segment;
a second segment;
a third segment;
a first connection point; and
a second connection point;
wherein the first segment and the second segment attach at the first connection point, forming a first angle therebetween, wherein the second segment and the third segment attach at the second connection point, forming a second angle therebetween;
a first friction element and a second friction element, wherein the first friction element is connected to the third segment of the first arm and the second friction element is connected to the third segment of the second arm; and
a compression element, wherein the first segment of each of the first arm and the second arm are compressably attached to the compression element, such that a force applied to at least one of the connected first arm and the first friction element and the connected second arm and the second friction element results in the compression element and at least one of the connected first arm and the first friction element and the connected second arm and the second friction element exerting a suspending force so as to suspend a luminaire to which the luminaire suspension mechanism is attached within a cavity.

2. The luminaire suspension mechanism of claim 1, wherein the first arm has a lower surface and an upper surface, and wherein the second arm has an upper surface and a lower surface.

3. The luminaire suspension mechanism of claim 2, wherein a first arc created between the upper surface of the first arm and the upper surface of the second arm about the compression element has an angle of less than 180°.

4. The luminaire suspension mechanism of claim 3, wherein a second arc created between the lower surface of the first arm and the lower surface of the second arm about the compression element has an angle of greater than 180°.

5. The luminaire suspension mechanism of claim 4, wherein the second arc does not intersect the upper surface of the first arm or the upper surface of the second arm.

6. The luminaire suspension mechanism of claim 2, wherein a first connection angle is formed on the lower surface of the first arm between the first segment and the second segment of the first arm.

7. The luminaire suspension mechanism of claim 6, wherein a second connection angle is formed on the upper surface of the first arm between the second segment and the third segment of the first arm.

8. The luminaire suspension mechanism of claim 7, wherein at least one of the first connection angle and the second connection angle is obtuse.

9. The luminaire suspension mechanism of claim 7, wherein the first connection angle is obtuse, and wherein the second connection angle is obtuse.

10. The luminaire suspension mechanism of claim 7, wherein a third connection angle is formed on the lower surface of the second arm between the first segment and the second segment of the second arm.

11. The luminaire suspension mechanism of claim 10, wherein a fourth connection angle is formed on the upper surface of the second arm between the second segment and the third segment of the second arm.

12. The luminaire suspension mechanism of claim 11, wherein at least one of the third connection angle and the fourth connection angle is obtuse.

13. The luminaire suspension mechanism of claim 11, wherein the third connection angle is obtuse, and wherein the fourth connection angle is obtuse.

14. The luminaire suspension mechanism of claim 1, wherein the compression element is a torsion spring.

15. The luminaire suspension mechanism of claim 14, wherein the torsion spring has at least two windings.

16. The luminaire suspension mechanism of claim 1, wherein the first friction element and the second friction element each have a curved end and a pinched end.

17. The luminaire suspension mechanism of claim 1, wherein the first arm, the second arm, the first friction element, the second friction element, and the compression element are formed from the same piece of material.

18. The luminaire suspension mechanism of claim 1, wherein the suspending force exerted by the compression element and at least one of the connected first arm and the first friction element and the connected second arm and the second friction element includes a pulling force that results in the luminaire being at least partially pulled into the cavity.
